(19) United States
(12) Patent Application Publication
(10) Pub. No.: US 2004/0257056 A1
(43) Pub. Date: Dec. 23, 2004

(54) Switching regulator with improved load transient efficiency and method thereof

(76) Inventors: Jian-Rong Huang, Hsinchu City (TW); Liang-Pin Tai, Tainan (TW); Kent Huang, Taoyuan (TW); Hung-I Wang, Changhua (TW); Cheng-Hsuan Fan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/840,370

(22) Filed: May 7, 2004

(30) Foreign Application Priority Data
May 9, 2003 (TW) 092112736

(51) Int. Cl. G05F 1/40

(52) U.S. Cl. 323/282

(57) ABSTRACT

A switching regulator with improved load transient efficiency comprises an output stage to generate an output voltage, a pulse width modulation circuit to generate a pulse width modulation signal, a constant ON-time circuit to generate an ON-time signal in accordance with the pulse width modulation signal to drive the output stage, and a masking apparatus to mask the ON-time signal by the pulse width modulation signal to thereby drive the output stage during load transient. During load transient, the masking apparatus reduces the switching times of the output stage to thereby reduce the switching loss and thus improve the efficiency of the regulator.

### FIELD OF THE INVENTION

The present invention relates generally to a switching regulator and, more particularly, to the load transient efficiency improvement of a switching regulator.

### BACKGROUND OF THE INVENTION

Due to the excellent performance, switching regulator is widely applied for various electronic apparatus. Even the switching regulator has high efficiency, several arts are proposed to improve its efficiency for the battery to provide longer lifetime for used by the switching regulator.

FIG. 1 shows a conventional switching regulator 10, which comprises an output stage 12 to generate an output voltage Vout through an inductor L to its load circuit, a current sense circuit 12 to detect the current I_{L} on the inductor L to generate a current sense signal V_{IS}, a voltage divider composed of two resistors R₁ and R₂ to detect the output voltage Vout to generate a feedback voltage V_{FB}, a pulse width modulation (PWM) circuit 16 to generate a pulse width modulation signal PM in accordance with the current sense signal V_{IS} and the feedback voltage V_{FB}, a constant ON-time circuit 18 to generate an ON-time signal T_{ON} to regulate the output voltage Vout under the pulse width modulation signal PM, and two driver 20 and 22 to drive the output stage 12. The output stage 12 includes a high-side switch 122 connected between a power source supplied voltage VDD and a phase node 124, and a low-side switch 126 connected between the node 124 and ground GND. The output inductor L is connected between the node 124 and the output Vout, with a sense resistor Rs of the current sense circuit 14 inserted between the inductor L and the output Vout to detect the inductor current I_{L}. An output capacitor C is connected between the output Vout and ground GND, which has an equivalent series resistance R_{ESR}. The voltage divider resistors R₁ and R₂ divide the output voltage Vout to generate the feedback voltage V_{FB}. The pulse width modulation circuit 16 includes an error amplifier 162 with its non-inverting input connected with the feedback voltage V_{FB} and inverting input connected with a reference voltage V_{REF} to generate an error signal V_{EA} by comparing therebetween, an adder 164 to sum the error signal V_{EA} and the current sense signal V_{IS} to generate a ramp signal V_{RAMP}, and a comparator 166 with its non-inverting input connected with the ramp signal V_{RAMP} and inverting input connected with the reference voltage V_{REF} to generate the pulse width modulation signal PM.

FIG. 2 shows another conventional switching regulator 24, which also comprises the output stage 12, the pulse width modulation circuit 16, the constant ON-time circuit 18, and the drivers 20 and 22. However, there is no current sense circuit 14 in the regulator 24 as the regulator 10 is, and the pulse width modulation signal PM is directly generated by the error amplifier 162.

The output voltage Vout of the regulator 10 or 24 is regulated by use of the duty cycle of the driving signal of the pair of high-side switch 122 and low-side switch 124. However, during load transient, the output voltage Vout rapidly drops to about the level of I_{L}×R_{ESR}, and to maintain the output voltage Vout at the target level, it is needed to increase the switching frequency of the high-side switch 122 and low-side switch 124. FIG. 3 shows the waveform of various signals in the circuit of FIG. 1, in which waveform 30 is representative of the inductor current I_{L}, waveform 32 is representative of the ramp signal V_{RAMP}, waveform 34 is representative of the reference voltage V_{REF}, waveform 36 is representative of the pulse width modulation signal PM, waveform 38 is representative of the ON-time signal T_{ON}, waveform 40 is representative of the OFF-time signal T_{offmin}, waveform 42 is representative of the driving signal UG of the high-side switch 122, and waveform 44 is representative of the output voltage Vout. As shown in FIG. 3, when load transient is occurred to the switching regulator 10 from light load to heavy load, the inductor current I_{L} increases, and the output voltage Vout rapidly drops, as shown by the waveforms 30 and 44. Responsive to the rapidly dropped output voltage Vout, the ramp signal V_{RAMP} also rapidly drops to a very low level, as shown by the waveform 32, thereby the duty cycle of the pulse width modulation signal PM becomes larger, as shown by the waveform 36. Once the ramp signal V_{RAMP} is lower than the reference voltage V_{REF}, a constant ON-time signal T_{ON} will be produced for the high-side switch 122, and the minimum OFF-time signal follows thereto to for stabilization of the system, as shown by the waveforms 38 and 40. During the load transient, to recover the output voltage Vout to the original level, the ON-time signal T_{ON} has to be increased its switching frequency, as shown by the waveform 38. However, due to the frequency of the ON-time signal T_{ON} increasing, the switching times of the high-side switch 122 and low-side switch 126 increase, which causes a larger switching loss and thus reduces the efficiency of the switching regulator 10.

Therefore, it is desired a switching regulator with improved load transient efficiency.

### SUMMARY OF THE INVENTION

One object of the present invention is to provide a switching regulator with improved load transient efficiency.

According to the present invention, a switching regulator with improved load transient efficiency comprises an output stage to generate an output voltage through an inductor, a pulse width modulation circuit to generate a pulse width modulation signal, a constant ON-time circuit to generate the ON-time signal to drive the output stage in accordance with the pulse width modulation signal, and a masking apparatus to mask the ON-time signal by the pulse width modulation signal to drive the output stage during load transient. During load transient, the masking apparatus reduces the switching times of the switches of the output stage, thereby reducing the switching loss and improving the efficiency of the regulator.

In another embodiment, a switching regulator with improved load transient efficiency comprises an output stage to generate an output voltage through an inductor, a pulse width modulation circuit to generate a pulse width modulation signal, and an ON-time circuit to generate an ON-time signal to drive the output stage in accordance with the pulse width modulation signal, the duty cycle of the pulse width modulation signal is used for the duty cycle of the ON-time signal during load transient, and by which the switching times of the output stage are reduced, the switching loss is reduced accordingly, and the efficiency of the regulator is improved.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a conventional switching regulator;

FIG. 2 shows another conventional switching regulator;

FIG. 3 shows the waveform of various signals in the circuit of FIG. 1;

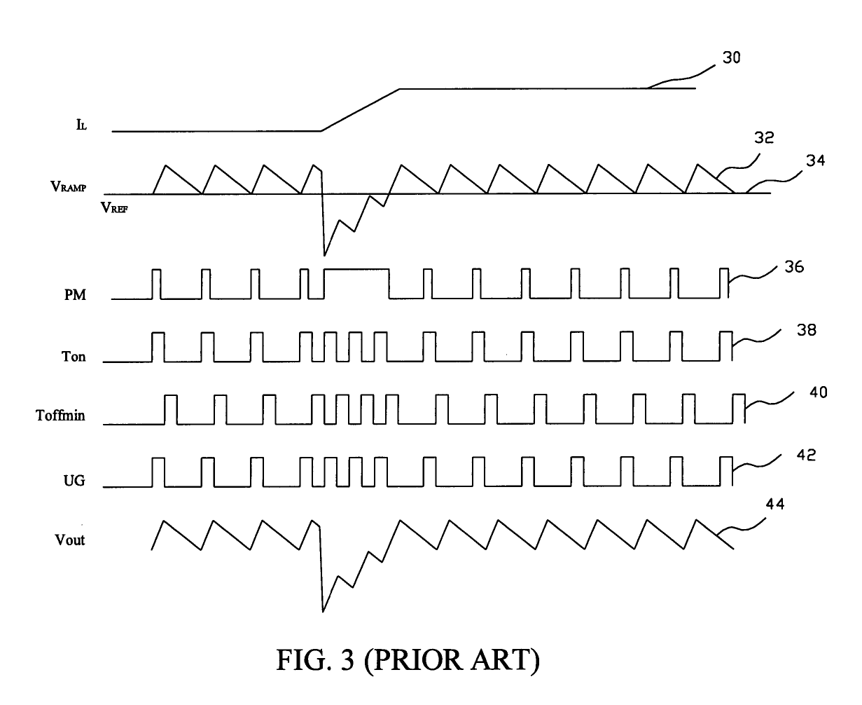

FIG. 4 shows a switching regulator according to the present invention;

FIG. 5 shows the waveform of various signals in the circuit of FIG. 4;

FIG. 6 shows an ON-time circuit for the circuit of FIG. 4; and

FIG. 7 shows the waveform of various signals in the circuit of FIG. 6.

### DETAILED DESCRIPTION OF THE INVENTION

There is provided a technique to mask the constant ON-time signal T_{ON} during load transient, so as to enlarge the duty cycle. As a result, the switching times of the output stage are reduced, the switching loss is reduced, and the efficiency of the regulator is improved.

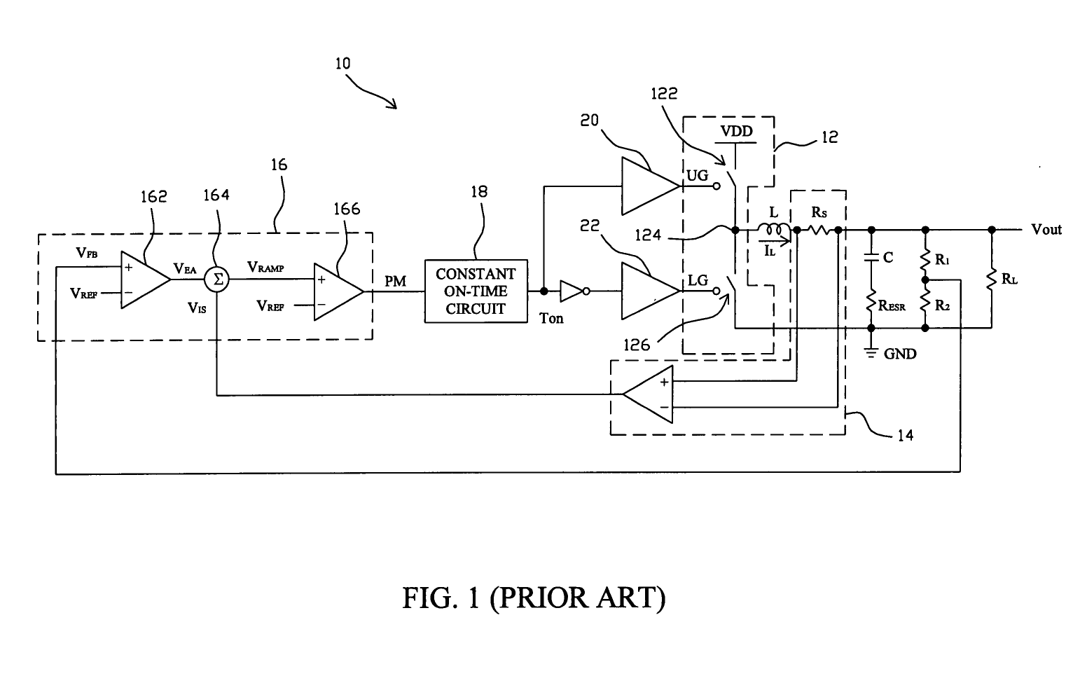

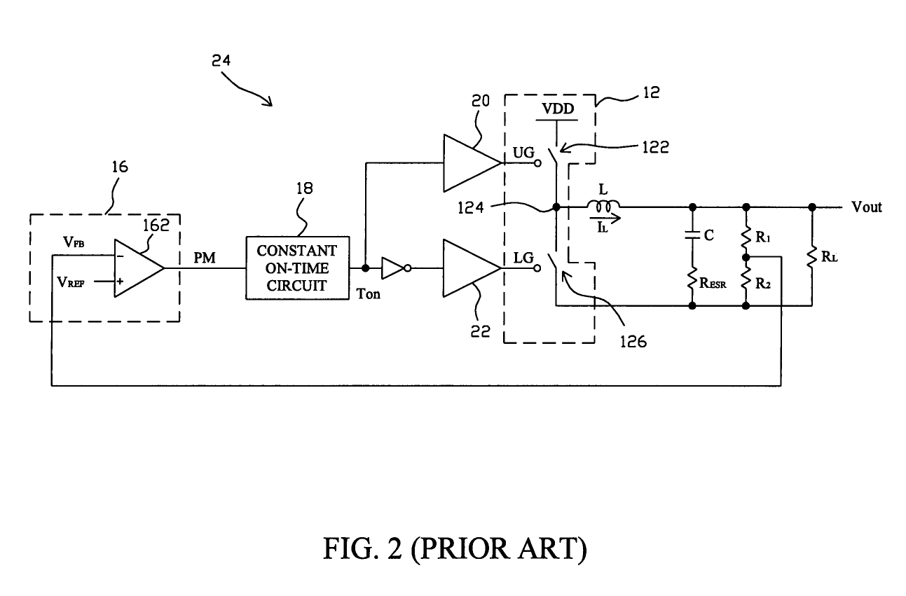

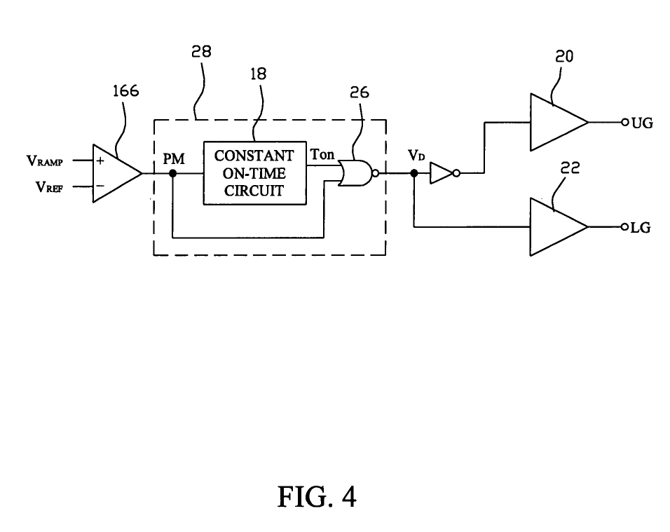

Based on the scheme that is shown by the switching regulator 10 or 24 of FIG. 1 or FIG. 2, FIG. 4 shows a part circuit of a switching regulator according to the present invention, which comprises the comparator 166 to compare the ramp signal V_{RAMP} with the reference voltage V_{REF} to generate the pulse width modulation signal PM, and an ON-time circuit 28 to generate an ON-time signal V_{D} in accordance with the pulse width modulation signal PM for the drivers 20 and 22 to drive the output stage 12, wherein the duty cycle of the pulse width modulation signal PM is used for the duty cycle of the ON-time signal V_{D} during the load transient of this regulator. In addition to the constant ON-time circuit 18 to generate the signal T_{ON} in accordance with the pulse width modulation signal PM for normal operations of this regulator as a conventional one does, the ON-time circuit 28 further comprises a NOR gate 26 having its two inputs connected with the signal T_{ON} and the pulse width modulation signal PM, respectively, to generate the output V_{D}, in order to switch the high-side switch 122 and low-side switch 124 by the drivers 20 and 22. By NORing the signal T_{ON} and the pulse width modulation signal PM, the duty cycle of the ON-time signal V_{D} will be the same as that of the signal T_{ON} generated by the constant ON-time circuit 18 at steady state, as a conventional regulator does. However, once load transient occurred, the duty cycle of the ON-time signal V_{D} will be directly determined by the pulse width modulation signal PM, since the duty cycle of the pulse width modulation signal PM is larger than that of the signal T_{ON} at load transient. In other words, the NOR gate 26 serves as a masking apparatus at load transient to mask the signal T_{ON} by the pulse width modulation signal PM. Those skilled in the art should understand that such masking apparatus can be implemented with any other circuits, only that it is able to mask the signal T_{ON} by the pulse width modulation signal PM when load transient is occurred.

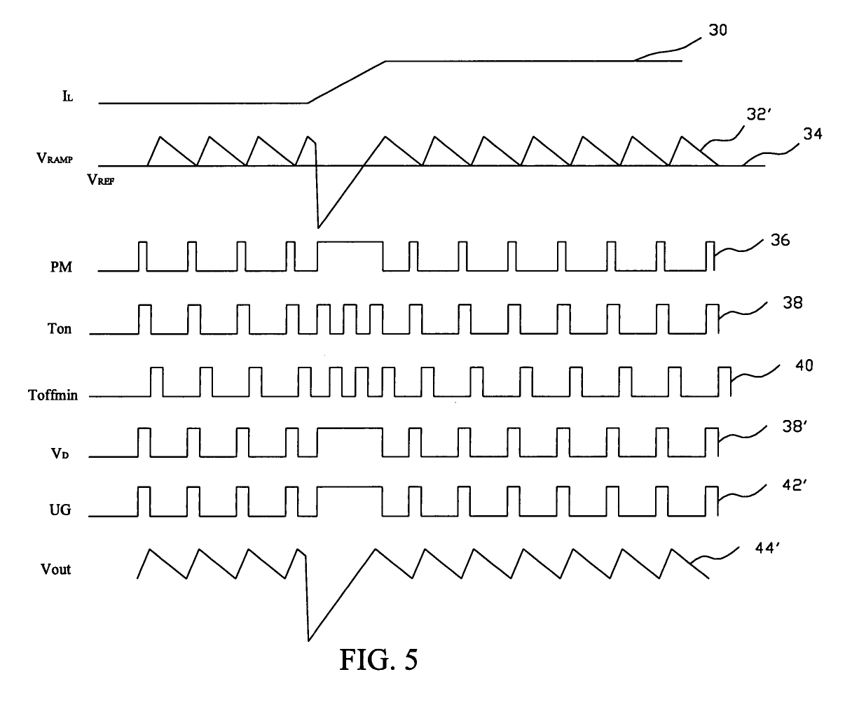

FIG. 5 shows the waveform of various signals in the circuit of FIG. 4, in which waveform 30 is representative of the inductor current I_{L}, waveform 32′ is representative of the ramp signal V_{RAMP}, waveform 34 is representative of the reference voltage V_{REF}, waveform 36 is representative of the pulse width modulation signal PM, waveform 38 is representative of the signal T_{ON}, waveform 40 is representative of the OFF-time signal T_{offmin}, waveform 38′ is representative of the output V_{D} of the NOR gate 26, waveform 42′ is representative of the driving signal UG of the high-side switch 122, and waveform 44′ is representative of the output voltage Vout. In normal operation, the duty cycle of the pulse width modulation signal PM is smaller than that of the signal T_{ON}, and therefore the duty cycle of the output V_{D} of the NOR gate 26 is the same as that of the signal T_{ON}. During load transient, the duty cycle of the pulse width modulation signal PM is larger than that of the signal T_{ON}, and therefore the duty cycle of the output V_{D} of the NOR gate 26 is the same as that of the pulse width modulation signal PM. In other words, this switching regulator will behave the same as a conventional one in normal operations, while its high-side switch 122 only switches once during load transient by following the pulse width modulation signal PM, thereby reducing the switching loss and improving the efficiency due to the less switching times.

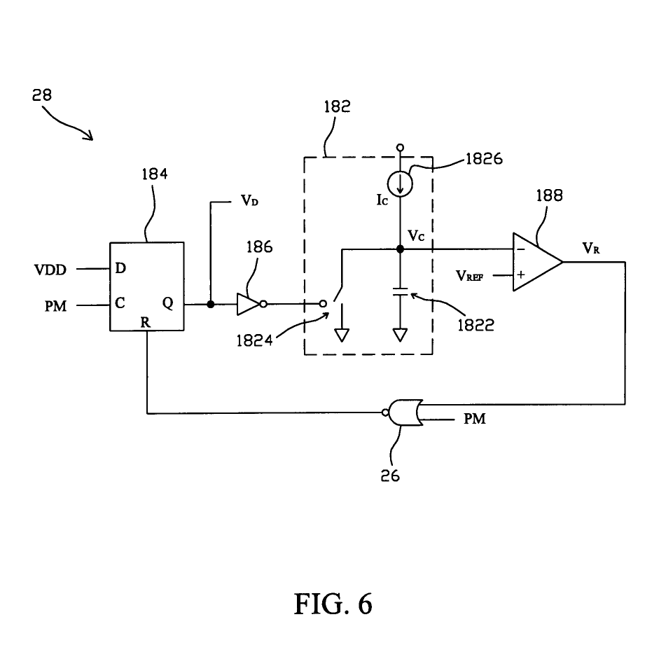

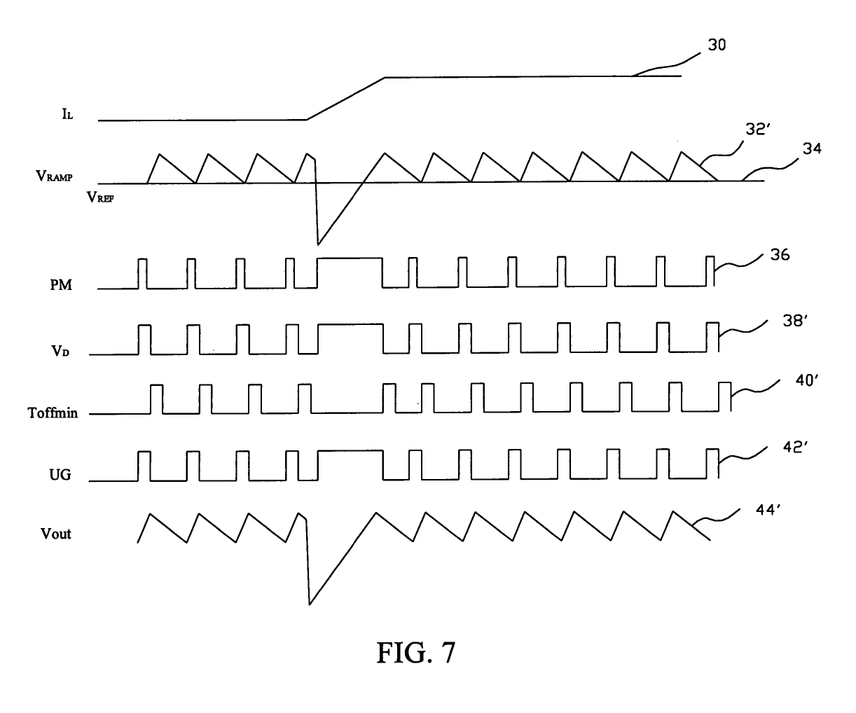

The constant ON-time circuit 18 and NOR gate 26 are able to be integrated as the ON-time circuit 28 shown in FIG. 6, which comprises a charging circuit 182 having a capacitor 1822 shunt connected by a switch 1824, and a current source 1826 providing a charging current I_{C} to charge the capacitor 1822 to generate a charging voltage V_{C}, a D-flip-flop 184 having its input D connected with the power source supplied voltage VDD, input C connected with the pulse width modulation signal PM, reset input R connected with a reset signal, and output Q to output the ON-time signal V_{D}, an inverter 186 connected between the output Q and the charging circuit 182, a comparator 188 to compare the charging voltage V_{C} with the reference voltage V_{REF} to generate the reset signal V_{R}, and the NOR gate 26 to NOR the reset signal V_{R} and the pulse width modulation signal PM to reset the D-flip-flop 184 only when the reset signal V_{R} and the pulse width modulation signal PM are both at low level. As a result, during load transient, the duty cycle of the output V_{D} of the ON-time circuit 28 is determined by the pulse width modulation signal PM and it is a larger one than that of the conventional regulator, as shown in the waveform 38′ of FIG. 7, by which the high-side switch 122 is switched only once in order to reduce the switching loss and improve the efficiency.

FIG. 7 shows the waveform of various signals in the circuit of FIG. 6, in which waveform 30 is representative of the inductor current I_{L}, waveform 32 is representative of the ramp signal V_{RAMP}, waveform 34 is representative of the reference voltage V_{REF}, waveform 36 is representative of the pulse width modulation signal PM, waveform 38′ is representative of the ON-time signal V_{D}, waveform 40′ is representative of the OFF-time signal T_{offmin}, waveform 42′ is representative of the driving signal UG of the high-side switch 122, and waveform 44 is representative of the output voltage Vout.

In the above embodiments, the NOR gate 26 is used as a masking apparatus to cover the original ON-time signal T_{ON} by the pulse width modulation signal PM to enlarge the duty cycle during load transient, so as to reduce the switching times of the high-side switch 122 and low-side switch 126 to reduce the switching loss and improve the efficiency of the regulator. However, the NOR gate 26 is an exemplatory design for illustration of the present invention, and other modifications or variations are able to serve as the masking apparatus to achieve the same function and effect.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A switching regulator with improved load transient efficiency, comprising:
an output stage for generating an output voltage;
a pulse width modulation circuit for generating a pulse width modulation signal;
a constant ON-time circuit for generating an ON-time signal in accordance with said pulse width modulation signal to drive said output stage; and
a masking apparatus for masking said ON-time signal by said pulse width modulation signal to drive said output stage during said load transient.

2. The regulator of claim 1, wherein said constant ON-time circuit comprises:
a flip-flop responsive to said pulse width modulation signal for generating said ON-time signal;
a charging circuit controlled by said ON-time signal for generating a charging voltage; and
a comparator for comparing said charging voltage with a reference voltage for generating a reset signal to reset said flip-flop once said charging voltage reaching said reference voltage.

3. The regulator of claim 2, wherein said charging circuit comprises:
a current source for proving a charging current;
a capacitor charged by said charging current to generate said charging voltage; and
a switch controlled by said ON-time signal to discharge said capacitor.

4. The regulator of claim 1, wherein said masking apparatus comprises a NOR gate having two inputs connected with said pulse width modulation signal and ON-time signal, respectively, and an output connected to said output stage.

5. A method for improving load transient efficiency of a switching regulator, comprising the steps of:
generating a pulse width modulation signal;
generating an ON-time signal with a duty cycle in accordance with said pulse width modulation signal for driving an output stage of said switching regulator to thereby generate an output voltage; and
masking said ON-time signal by a signal having a second duty cycle larger than said duty cycle to drive said output stage during said load transient.

6. The method of claim 5, wherein said signal having second duty cycle is generated from said pulse width modulation signal.

7. A switching regulator with improved load transient efficiency, comprising:
an output stage for generating an output voltage;
a pulse width modulation circuit for generating a pulse width modulation signal; and
an ON-time circuit for generating an ON-time signal in accordance with said pulse width modulation signal to drive said output stage, wherein a duty cycle of said pulse width modulation signal is used for a duty cycle of said ON-time signal during said load transient.

8. The regulator of claim 7, wherein said ON-time circuit comprises:
a flip-flop responsive to said pulse width modulation signal for generating said ON-time signal;
a charging circuit controlled by said ON-time signal for generating a charging voltage; and
a comparator for comparing said charging voltage with a reference voltage for generating a reset signal once said charging voltage reaching said reference voltage; and
a NOR gate having two inputs connected with said pulse width modulation signal and reset signal, respectively, and an output for resetting said flip-flop.

9. The regulator of claim 8, wherein said charging circuit comprises:
a current source for proving a charging current;
a capacitor charged by said charging current to generate said charging voltage; and
a switch controlled by said ON-time signal to discharge said capacitor.

10. A method for improving load transient efficiency of a switching regulator, comprising the steps of:
generating a pulse width modulation signal;
generating an ON-time signal in accordance with said pulse width modulation signal for driving an output stage of said switching regulator to thereby generate an output voltage, wherein a duty cycle of said pulse width modulation signal is used for a duty cycle of said ON-time signal during said load transient.
